(19) United States
(12) Patent Application Publication
(10) Pub. No.: US 2015/0063942 A1
(43) Pub. Date: Mar. 5, 2015

(54) EXPANDABLE FASTENER

(71) Applicant: Thomas D. Auer, Wildwood, MO (US)

(72) Inventor: Thomas D. Auer, Wildwood, MO (US)

(21) Appl. No.: 14/012,488

(22) Filed: Aug. 28, 2013

(51) Int. Cl. F16B 13/06

(52) U.S. Cl. CPC F16B 13/06
USPC 411/19; 29/525.01

(57) ABSTRACT

An expandable fastener provides a fastener having a hollow tube in fluid communication with a flexible membrane forming a bladder around the tube. After the tube is inserted into the panel the bladder is filled with a curable fluid such as an expanding foam, which inflates the bladder against the rear surface of the panel. When the fluid cures it forms a substantially inflexible retaining block that contacts the panel over a large surface area, distributing any longitudinal pulling force applied against the fastener over a broad area of the panel to improve resistance to dislodgment and minimize panel failure.

### FIELD OF THE INVENTION

This invention relates to fasteners. In particular, this invention relates to an expandable fastener, for example for mounting screws to drywall panels, which provides broad surface contact against the panel to resist dislodgment.

### BACKGROUND OF THE INVENTION

Drywall, or plaster wallboard, is cheap and easy to install, making it one of the most popular finishing surfaces for walls and ceilings. Typically drywall panels are nailed or screwed onto a wood or metal frame, and plaster or drywall compound is applied to the seams between panels to finish the wall or ceiling surface.

Frequently it is desirable to fasten an article or structure to a wall or ceiling, for example when mounting shelves. Drywall is composed of a plaster layer sandwiched between outer paper layers, and as such is relatively weak in the transverse direction, especially when the paper coating has been broken. However, the studs or joists of the wall or ceiling frame may not be aligned to permit the article or structure to be fastened directly to the frame in the desired position. In such cases the article or structure must be fastened to the drywall panel.

There are two conventional fasteners primarily used for this purpose: a screw set into an anchoring plug embedded in the drywall; and bolt bearing extendible arms that are retracted to allow the fastener to be inserted through a hole in the panel, and extended to bear against the rear surface of the panel when the bolt is tightened.

Screws cannot be fastened directly to drywall because the threads strip out the plaster when even a slight longitudinal force is applied to the screw. Accordingly, to provide a more secure anchoring force an anchoring plug is lodged in the drywall and the screw is fastened into the anchoring plug. This provides a certain amount of resistance to longitudinal dislodgment of the screw.

For example, one popular type of anchoring plug consists of a hollow plastic body having a hole for receiving the screw and a ribbed exterior for engaging the plaster surrounding the hole in the drywall. The ribbing provides resistance to longitudinal dislodgment, which is augmented as the screw is driven into the plug and expands the plug, compressing the plug body against the surrounding plaster. However, the resistance of this type of fastener to longitudinal dislodgment remains limited, because it relies solely on an interference fit with a very small surface area, i.e. the layer of plaster immediately surrounding the plug, for resistance to dislodgment.

Moreover, the anchoring plug tends to cause the plaster surrounding it to crumble when the plug expands as a screw is driven into it, decreasing the integrity of the surrounding drywall and further reducing resistance to dislodgment. If such a plug dislodges it inevitably leaves a larger hole than was initially drilled to hold the plug; thus, once the anchoring plug becomes dislodged it is usually not possible to replace the plug with a plug of the same size without first repairing the damage caused by the dislodged plug.

A fastener having extendible arms that open after the fastener has been inserted into the drywall panel and bear against the rear surface of the panel has a stronger anchoring force. For example, a so-called “butterfly” fastener comprises a bolt threaded through a pair of extendible arms which can be retracted to insert the fastener through a hole in the drywall, and then spring open so that when the bolt is tightened the arms bear against the rear face of the drywall.

These types of expanding fasteners provide improved resistance to longitudinal dislodgment, because the retaining wings overlay solid drywall. However, the force of the wings against the drywall is confined to a limited area, and accordingly there is a limit to the amount of longitudinal pulling force that can be exerted on the fastener before the wings shear or break through the panel. Also, once the fastener is installed if the bolt is removed the wings will fall into the wall cavity.

A variation of the butterfly fastener is described and illustrated in U.S. Pat. No. 5,725,341 issued Mar. 10, 1998 to Hofmeister, which is incorporated herein by reference. This fastener has a main tube divided into flexible radial segments and a nut at its base. Tightening a bolt disposed through the tube draws the nut toward the neck of the tube, compressing the tube lengthwise and forcing the segments to collapse onto the back of the panel as retaining wings. The wings lay flush against the rear face of the panel to resist longitudinal dislodgment of the fastener. The tube contains an epoxy packet which is punctured as the bolt is driven into the tube, and the epoxy secures or fuses the plug components together.

The Hofmeister device still relies largely upon engagement between the plug and the drywall to resist dislodgment, and the use of an expensive epoxy compound in combination with the mechanical means achieves only relatively minor enhancement in performance. Further, having a size limited to the tube interior diameter the epoxy packet can contain only a very limited amount of epoxy, and the epoxy is prone to falling into the wall cavity as the packet is punctured.

It would accordingly be advantageous to provide a fastener which contacts the panel over a broad surface area, to maximize resistance to longitudinal dislodgment, and retain its engagement with the drywall when the screw or bolt is removed.

It would also be advantageous to provide such a fastener with a retaining structure that is flexible during installation, to permit the plug to be inserted through a relatively small hole in the drywall, but becomes substantially inflexible after installation.

It would further be advantageous to provide a fastener which repairs damage to the drywall from drilling or from prior dislodgment of a conventional anchoring plug.

In the preferred embodiments the present invention provides these advantages by providing a fastener having a hollow tube in fluid communication with a flexible membrane forming a bladder around the tube. After the tube is inserted into the panel the bladder is filled with a curable fluid such as an expanding foam, which inflates the bladder and adheres it to the rear surface of the panel. When the fluid cures it forms a substantially inflexible retaining block that contacts the panel over a broad surface area, distributing a pulling force over a larger area of the panel to improve resistance to dislodgment. In the preferred embodiment a compressing member, for example a bolt extending through the tube into a nut, draws the retaining block against the panel to compressively engage the fastener to the panel.

In one preferred embodiment the fluid is injected into the fastener through the neck of the tube. In a further embodiment the fluid may be contained in a pressurized capsule within the tube, which may be pierced by the tip of the bolt as the bolt is driven into the tube.

The present invention thus provides a fastener, comprising a hollow tube having an outer end and an inner end, the outer end being provided with a stop for preventing the passage of the outer end of the tube through a hole in a wall, at least one opening through a wall of the tube, and a flexible bladder disposed over the tube and anchored thereto, the opening in the tube being in fluid communication with an interior of the bladder, wherein when the fastener is disposed through a panel and a curable fluid is injected into the tube the fluid inflates the bladder, such that the fluid cures to form a substantially inflexible retaining block to retain the tube against longitudinal dislodgment from the panel.

In a preferred embodiment a compressing member for drawing the bladder toward the outer end of the tube comprises a bolt cooperating with a nut.

The present invention further provides a method of affixing a fastener to a panel, comprising the steps of a) inserting a hollow tube and a bladder anchored to an inner end thereof and disposed over the tube into a hole in the panel, until a stop about an outer end of the tube contacts the panel, and b) inflating the bladder by injecting a curable fluid into the tube and through at least one opening in a wall of the tube in fluid communication with an interior of the bladder.

In a further preferred embodiment the method comprises the additional steps of c) allowing the curable fluid to cure, and d) compressively drawing the bladder toward the outer end of the tube.

### BRIEF DESCRIPTION OF THE DRAWINGS

In drawings which illustrate by way of example only a preferred embodiment of the invention,

FIG. 1 is an exploded cross-section of a preferred embodiment of a fastener according to the invention,

FIG. 2 is a cross-section of a fastener of the invention lodged in a hole in a wall panel, and

FIG. 3 is a cross-section of the fastener of FIG. 2 after inflation of the bladder and compression of the tube to draw the bladder toward the panel.

### DETAILED DESCRIPTION OF THE PREFERRED EMBODIMENT

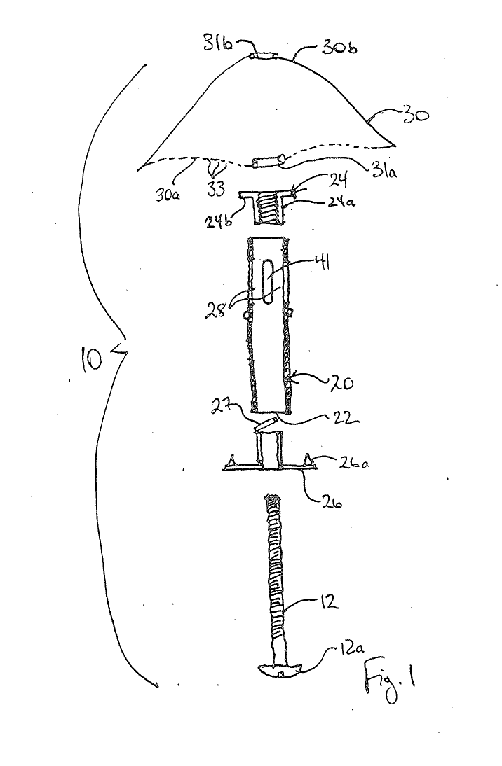

FIGS. 1 to 3 illustrate a first preferred embodiment of a fastener 10 according to the invention. The fastener 10 is particularly suitable for fastening an article or structure to a panel, such as a drywall panel 4 in a hollow wall 2 having a wooden or metal frame 6. However, the fastener may be used in other applications, and the invention is not intended to be so limited.

In the preferred embodiment the fastener 10 comprises a tube 20, for example a metal or plastic cylinder, having a stop, for example a flange 22, disposed about its outer end. The flange 22 may formed in a separate bushing or sleeve 26 adapted to fit into the outer end of the tube 20, as shown, or may be integrally formed with the tube 20. Optionally the flange 22 may be provided with teeth 26a (as shown in FIG. 1) to prevent rotation and thus facilitate installation of the fastener 10.

A flexible bladder 30, which may be formed from plastic, paper, or any other suitable flexible material, is in fluid communication with the tube 20. One example of a suitable material for the bladder 30 is Tyvec (trademark) manufactured by DuPont (trademark). The tube 20 extends through an opening 31a in the bladder 30, preferably in sliding relation so that the opening 31 a can slide along the tube 20 as the bladder 30 expands. The bladder 30 in the preferred embodiment is provided with perforations 33 through a proximal portion 30a of the bladder 30 that faces the panel 4 when the fastener 10 is inserted, for reasons described below. A distal portion 30b of the bladder 30 opposite to the proximal portion 30a is anchored to the tube 20 in the manner described below.

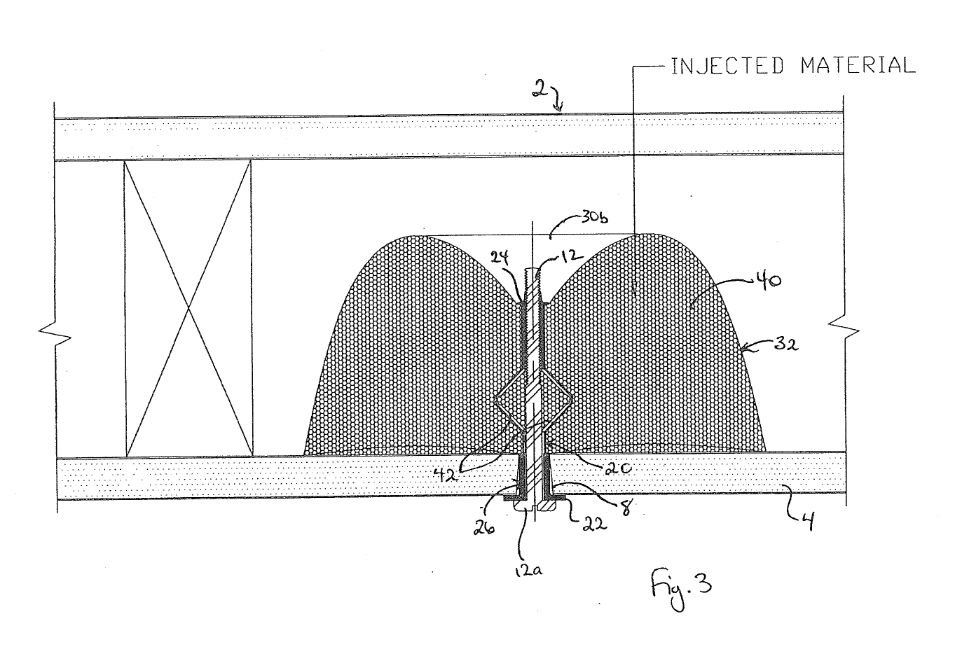

After the fastener 10 has been inserted through a hole 8 in the panel 4, the bladder 30 will be inflated by injecting a curable fluid, for example an expanding foam, through the hollow tube 20. Openings 41 in the wall of the tube 20 allow the curable fluid to egress into the bladder 30, which inflates the bladder 30 so that when the foam cures it forms a substantially inflexible retaining block 32, shown in FIG. 3, which secures the inner end of the tube 20 and bears against the rear surface of the panel 4 to retain the fastener 10 in the panel 4 and resist longitudinal pulling forces. The bladder 30 contains the spread of the curable fluid and prevents the curable fluid from falling into the wall cavity.

In the preferred embodiment the curable fluid also has adhesive properties, as many commercially available expandable foams do, and is thus permitted to seep out of the bladder 30 in the direction of the panel 4, for example through small perforations 33 through the proximal portion 30a of the bladder 30 (which faces the panel 4). This both retains the fastener 10 in position in the panel 4 and bonds any damaged portions of the panel 4 about the hole 8 to restore structural integrity to the panel 4.

In the preferred embodiment a compressing member is provided to draw the retaining block 32 against the rear surface of the panel 4, which compressively anchors the fastener 10 in the panel 4. In the embodiment shown, the portions of the wall of the tube 20 about the openings 41 form radial segments 28, which collapse and fold into wings 42 (see FIG. 3) when the tube 20 is compressed longitudinally by the compressing member.

In the preferred embodiment the compressing member comprises a threaded bolt 12 having a length sufficient to extend through the tube 20 and a head 12a that is too large to pass through the inner end of the tube 20, cooperating with a nut 24 abutting the inner end of the tube 20. The nut 24 may be affixed to or formed integrally with the tube 20, or may be separate from the tube 20 as shown, in which case the nut 24 is preferably formed with a neck 24a dimensioned to be press-fitted into the inner end of the tube 20, to prevent separation of the nut 24 from the tube 20 during installation. The nut 24 extends through an opening 31b in the distal portion 30b of the bladder 30, and is provided with a flange 24b that anchors the distal portion 30b of the bladder 30 to the tube 20. The bolt 12 is threaded through the nut 24 and tightened to draw the nut 24 toward the outer end of the tube 20 and tension the membrane 30, to thus compressively engage the retaining block 32 against the rear surface of the panel 4.

In the construction of the preferred embodiment, the inner end of the tube 20 is inserted into the opening 31 a in the bladder 30, the neck 24a of the nut 24 is disposed through the opening 31b, and the nut 24 is then pressed into the inner end of the tube 20. These components can be preassembled for sale to the consumer.

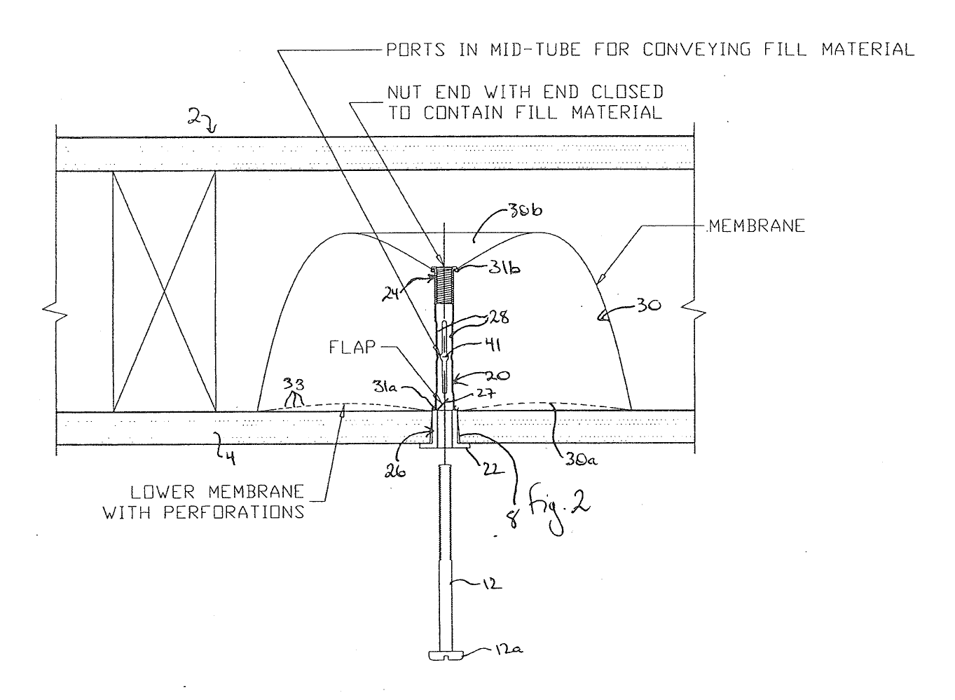

To install the fastener 10, a hole 8 sufficiently large to allow the nut 24 to pass through is drilled in the panel 4. The bladder 30 is pleated or folded around the tube 20 and the tube 20 is inserted through the hole in the panel 4 until the sleeve 26 contacts the front (exposed) surface of the panel 4, as shown in FIG. 2. A curable fluid, such as a commercially available expandable fast-curing foam 40, is injected through the tube 20 and flows through the openings 41 into the bladder 30, causing the bladder 30 to inflate. The foam 40 also seeps out of the perforations 33 in the proximal portion 30a of the bladder 30 to contact the panel 4 and form a base for the retaining block 32 that closely conforms to the panel surface and adheres the bladder to the panel 4, as shown in FIG. 3.

A check valve or flap 27 is preferably provided near the outer end of the tube 20, to prevent the expanding foam 40 from seeping out of the tube 20. In the embodiment shown the flap 27 is hingedly affixed to the sleeve 26, allowing foam 40 to be injected into the outer end of the tube 20, but closing off the tube 20 as the foam expands within the tube 20 and bladder 30. This ensures that the foam 40 expands into the bladder 30 with sufficient pressure to fully inflate the bladder 30, and prevents soiling or staining of the exposed surfaces of the panel 4. The flap 27 may tear away or fold back when the bolt 12 is inserted into the tube 20.

After the foam 40 cures to form a retaining block 32, the bolt 12 is pushed through the tube 20 and threaded into the nut 24. A typical expandable foam 40 will readily yield to the force of the bolt 12 being inserted into the tube 20 (if an epoxy, plaster, cement or some other hard curable material is used, it may be necessary to thread the bolt 12 to the nut 24 before the material has cured). The bolt 12 is rotated to draw the nut 24, and thus the cured retaining block 32, toward the outer end of the tube 20. In the embodiment shown this compresses the tube 20 and causes the radial segments 28 to collapse into wings 42, as shown in FIG. 3, as the panel 4 is compressively engaged between the retaining block 32 and the flange 26.

In this embodiment the bolt 12 can also be used to secure the article or structure (not shown) to the panel 4. In an alternative embodiment (not shown), the compressing member may be a pin (not shown) extending through the inner end of the tube 20 and projecting out of the neck 22, which compresses the tube 20 and then breaks away like a pop-rivet. In this case the installed tube 20 serves as a reinforced anchoring plug, and a separate screw or like fastener is used to fasten the article or structure to the tube 20.

Preferred embodiments of the invention having been thus described by way of example only, it will be apparent to those skilled in the art that certain modifications and adaptations may be made without departing from the scope of the invention. For example, without limiting the foregoing, although it is desirable to compressively engage the retaining block 32 against the pane 14, it may not always be necessary. The compressing member may comprise other structures that function to draw the retaining block 32 toward the outer end of the tube 20. Also, while use of an expandable foam 40 has been found to be advantageous other curable fluids (expanding or otherwise) can be used to inflate the bladder 30. The invention is intended to include all such modifications and adaptations as fall within the scope of the appended claims.

1. A fastener, comprising:
a hollow tube having an outer end and an inner end, the outer end being provided with a stop for preventing the passage of the outer end of the tube through a hole in a wall,
at least one opening through a wall of the tube, and
a flexible bladder disposed over the tube and anchored thereto, the opening in the tube being in fluid communication with an interior of the bladder, wherein when the fastener is disposed through a panel and a curable fluid is injected into the tube the fluid inflates the bladder, such that the fluid cures to form a substantially inflexible retaining block to retain the tube against longitudinal dislodgment from the panel.

2. The fastener of claim 1 in which a compressing member is disposed through the tube and engaged to the bladder, for drawing the bladder toward the outer end of the tube to compressively engage the retaining block against the panel.

3. The fastener of claim 2 in which the compressing member comprises a bolt cooperating with a nut affixed to the bladder.

4. The fastener of claim 3 in which the nut is affixed to the inner end of the tube.

5. The fastener of claim 1 in which the fluid comprises an expandable foam.

6. The fastener of claim 1 comprising a sleeve for engaging over a neck of the tube.

7. The fastener of claim 6 comprising a check valve for preventing an egress of curable fluid through the outer end of the tube.

8. The fastener of claim 3 in which the tube comprises a plurality of openings, portions of the tube wall between the openings being foldable to thereby collapse as the bladder is drawn toward the outer end of the tube.

9. The fastener of claim 4 in which the nut is provided with a neck disposed through an opening in the bladder and into the tube, to thereby anchor the bladder to the tube.

10. The fastener of claim 1 wherein a portion of the bladder facing the panel is provided with one or more perforations, such that the curable fluid can seep out of the bladder and contact the panel to adhere the fastener to the panel.

11. The fastener of claim 1 in which the stop comprises a flange.

12. The fastener of claim 11 in which the flange is formed about a sleeve engaged to the outer end of the tube.

13. A method of affixing a fastener to a panel, comprising the steps of
a) inserting a hollow tube and a bladder anchored to an inner end thereof and disposed over the tube into a hole in the panel, until a stop about an outer end of the tube contacts the panel, and
b) inflating the bladder by injecting a curable fluid into the tube and through at least one opening in a wall of the tube in fluid communication with an interior of the bladder.

14. The method of claim 13 further comprising the steps of:
c) allowing the curable fluid to cure, and
d) compressively drawing the bladder toward the outer end of the tube.

15. The method of claim 14 in which the step of compressively drawing the bladder is performed by a compressing member comprising a bolt cooperating with a nut.

16. The method of claim 15 in which the step of compressively drawing the bladder comprises the step of collapsing portions of a wall of the tube to compress the tube.

17. The method of claim 13 in which the fluid comprises an expandable foam.

18. The method of claim 13 in which the stop comprises a flange disposed about a sleeve engaged to the outer end of the tube.
